(19) United States
(12) Patent Application Publication
(10) Pub. No.: US 2025/0233362 A1
(43) Pub. Date: Jul. 17, 2025

(54) Electrical Connectors, Mating Connectors, and Connecting Elements

(71) Applicant: TE Connectivity Japan G. K., Kawasaki-shi (JP)

(72) Inventors: Yusuke Okada, Kawasaki-shi (JP); Eiichiro Takemasa, Kawasaki-shi (JP)

(73) Assignee: TE Connectivity Japan G. K., Kawasaki-shi (JP)

(21) Appl. No.: 19/014,429

(22) Filed: Jan. 9, 2025

(30) Foreign Application Priority Data
Jan. 12, 2024 (JP) 2024-003422

(51) Int. Cl. H01R 13/641

(52) U.S. Cl. CPC H01R 13/641

(57) ABSTRACT

An electrical connector includes a housing adapted to mate with a mating connector, and an indicator at least part of which is housed in the housing. The indicator includes a visual feature region movable as the housing mates with the mating connector from a non-display position to a display position in a mating direction. As the housing completely mates with the mating connector, the indicator moves from the non-display position to the display position where the visual feature region is viewable from outside the housing.

### CROSS-REFERENCE TO RELATED APPLICATION

This application claims the benefit of Japanese Patent Application No. 2024-003422 filed on Jan. 12, 2024, the whole disclosure of which is incorporated herein by reference.

### FIELD OF THE DISCLOSURE

The disclosure relates to connectors, mating connectors, and connecting elements.

### BACKGROUND OF THE INVENTION

In the prior art, a battery system is configured such that a plurality of batteries are connected via cables and connecting portions formed at both ends of the cables. A battery energy storage system or the like includes a large number of batteries and thus, a large numbers of cables and fastening portions are required for connecting the batteries.

The prior art discloses a cell monitoring connector attachable/detachable to/from a fuel cell. The cell monitoring connector includes a pair of parallel lever operating portions. The pair of lever operating portions are tilted relative to each other while being in the middle of being mounted on the fuel cell and return to the original parallel postures due to elasticity when completely mounted. Therefore, the lever operating portions can be recognized as being in the middle of being mounted while tilted relative to each other.

It is possible to determine that the pair of lever operating portions are not completely mounted on the cell according to their postures in the above described connector of the prior art. However, the pair of lever operating portions return to the original postures when completely mounted, and the completion of mounting cannot be directly confirmed. That is, the prior art describes that if the pair of lever operating portions are not tilted to each other, they are regarded as completely mounted and the completion of mounting is indirectly confirmed.

The present disclosure is therefore directed toward providing an electrical connector capable of visually confirming whether the electrical connector is completely mounted.

### SUMMARY OF THE INVENTION

According to an embodiment of the present disclosure, an electrical connector includes a housing adapted to mate with a mating connector, and an indicator at least part of which is housed in the housing. The indicator includes a visual feature region movable as the housing mates with the mating connector from a non-display position to a display position in a mating direction. As the housing completely mates with the mating connector, the indicator moves from the non-display position to the display position where the visual feature region is viewable from outside the housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is an isometric view depicting a connecting element configured of a cable connector and a battery connector according to an embodiment of the present invention.

FIG. 2 is an isometric view depicting the cable connector according to the embodiment of the present invention.

FIG. 3 is an isometric view depicting the battery connector according to the embodiment of the present invention.

FIG. 4 is a cross sectional view taken along the line IV-IV of FIG. 1.

FIG. 5 is a cross sectional view taken along the line V-V of FIG. 1.

FIG. 6 is a cross sectional view taken along the line VI-VI of FIG. 1.

FIG. 7 is a cross sectional view taken along the line VII-VII of FIG. 1.

FIG. 8 is a side view depicting the connecting element configured of the cable connector and the battery connector according to the embodiment of the present invention.

FIG. 9 is cross sectional views taken along the line IX-IX of FIG. 8.

FIG. 10 is isometric views depicting how to fasten the battery connector according to the embodiment of the present invention by way of example.

FIG. 11 is diagrams depicting exemplary visual feature regions displayed in a completely mating state according to the embodiment of the present invention.

FIG. 12 is a diagram depicting other exemplary indicator according to the embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An electrical connector according to the present invention includes a housing adapted to mate with a mating connector, and an indicator at least part of which is housed in the housing. The indicator has a visual feature region, and which moves, when the housing mates with the mating connector, from a non-display position to a display position in a mating direction. When the housing completely mates with the mating connector, the indicator moves to the display position where the visual feature region is viewable from outside the housing. Preferably, the housing includes a window for viewing the inside of the housing from the outside thereof, and the visual feature region is viewable through the window. Preferably, the indicator includes a driver which moves in a mating direction when the housing mates with the mating connector, and a follower which has the visual feature region and which moves from the non-display position to the display position in response to movement of the driver. When the housing completely mates with the mating connector, the follower moves to the display position where the visual feature region is viewable through the window. Preferably, when the housing completely mates with the mating connector, the indicator moves to the display position where the visual feature region displayed in a completely mating state in which the housing completely mates with the mating connector is viewable through the window. Preferably, when the housing does not completely mate with the mating connector, the indicator stays at the non-display position where the visual feature region is not viewable through the window or a region other than the visual feature region is viewable through the window. Preferably, the visual feature region is in a color different from the color of the housing. Preferably, the driver has a driver cam face which is tilted relative to the mating direction, and the follower has a follower cam face which slides along with the driver cam face. Preferably, the housing includes a pressing portion for applying load on the driver such that the follower stays at the non-display position when the housing does not completely mate with the mating connector. Preferably, when the housing completely mates with the mating connector, load is applied on the driver in a mating direction such that the follower stays at the display position.

A mating connector according to the present invention, which is to mate with the electrical connector according to the present invention, includes a housing to mate with the electrical connector, and a contact which is to be fastened to a conductive element with a fastening element and which is provided with a conductive fastening portion. A connecting element according to the present invention is configured of the electrical connector according to the present invention and the mating connector according to the present invention. According to the present invention, it is possible to provide an electrical connector capable of visually confirming whether the electrical connector is completely mounted.

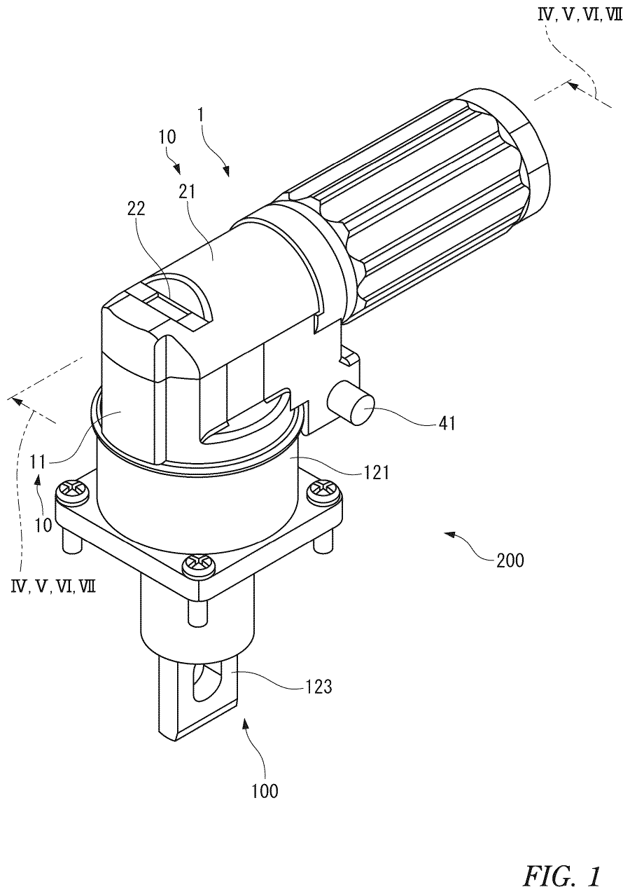

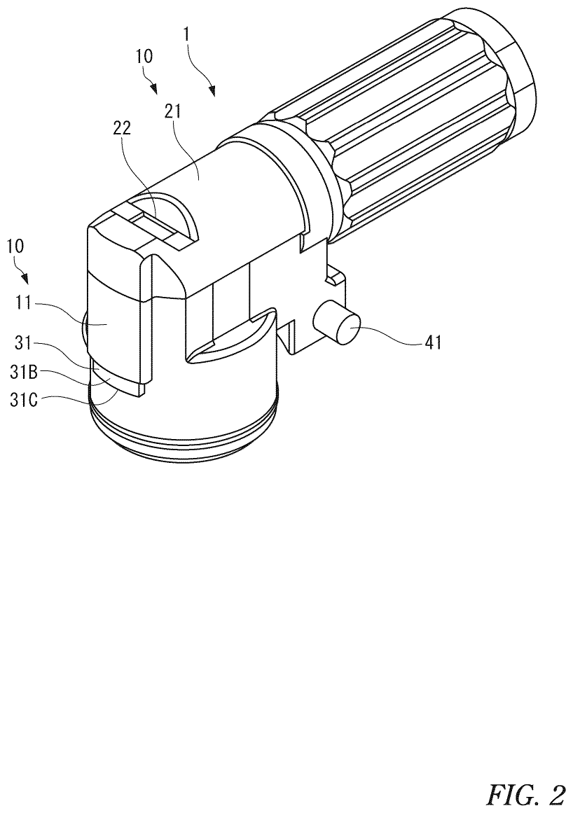

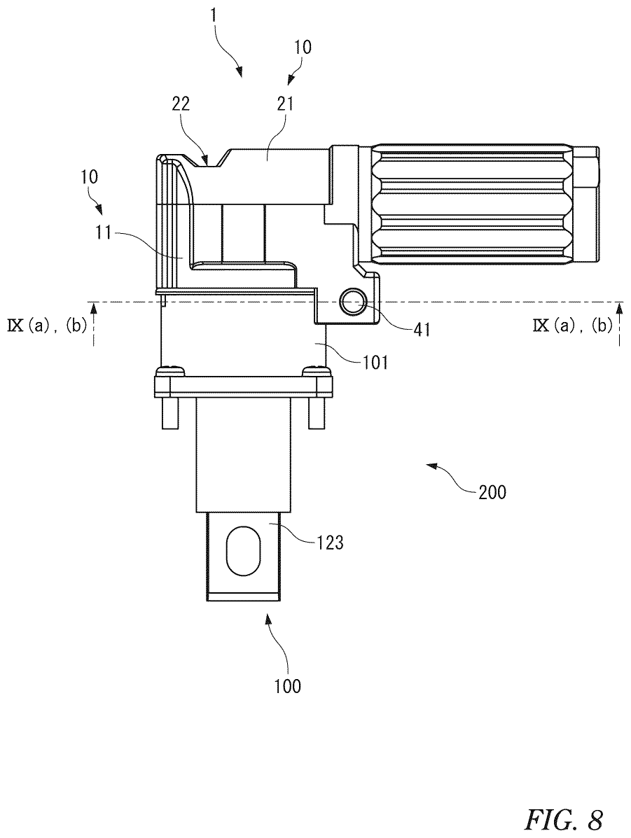

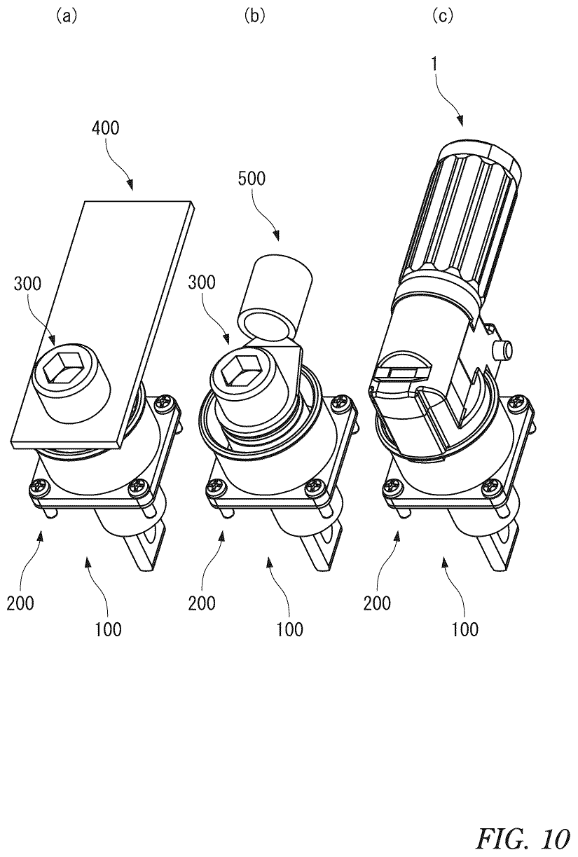

A cable connector 1, a battery connector 100, and a connecting element 200 configured of the cable connector 1 and the battery connector 100 according to an embodiment of the present invention will be described below with reference to the drawings. In this description, the term connection includes both electrical connection and mechanical connection. Additionally, for convenience of the following description, a direction in which the cable connector 1 and the battery connector 100 mate is assumed as third direction Z, a direction perpendicular to the third direction Z is assumed as first direction X, and a direction perpendicular to the first direction X is assumed as second direction Y as depicted in the respective Figures. Further, the front side and the back side in the first direction X are denoted as (F) and (B), respectively, the right side and the left side in the second direction Y are denoted as (R) and (L), respectively, and the upside and the downside in the third direction Z are denoted as (U) and (D), respectively. cl Cable Connector 1: See FIGS. 1, 2, and 4 to 10

The cable connector 1 as an electrical connector includes a housing 10 adapted to mate with the battery connector 100 and having a window, and an indicator 30 at least part of which is housed in the housing 10 and which has a visual feature region 33 viewable through a window 22. The housing 10 includes a socket housing 11 for housing at least part of the indicator 30, and an indicator housing 21 having the window 22. In the present embodiment, the cable connector 1 is a female connector and the battery connector 100 is a male connector. The cable connector 1 and the battery connector 100 are used as power supply connectors.

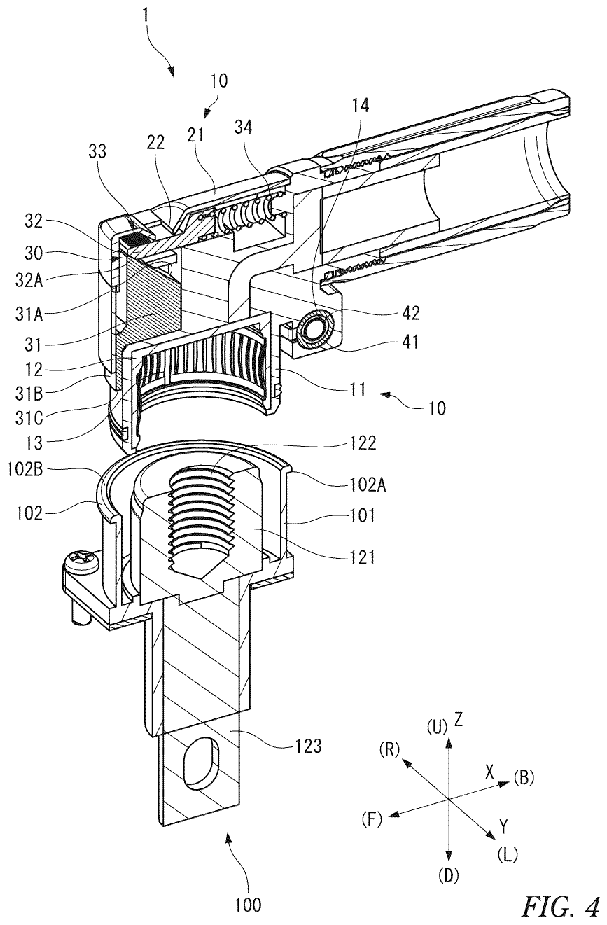

### Socket Housing 11: See FIGS. 4, 5, 6, 7, 8 and 9

The socket housing 11 includes a socket contact 12 into which a cable (not depicted) is connected and which is electrically connected to the battery connector 100, an annular crown contact 13 for electrically connecting the inner periphery of the socket contact 12 and the outer periphery of a contact 121 of the battery connector 100, and a latch housing 14 for housing at least part of a latch 41. The latch 41 is caught by a flange 102 of a housing 101 when the cable connector 1 mates with the housing 101 of the battery connector 100. The socket housing 11 houses at least part of the indicator 30. The socket housing 11 and the socket contact 12 are integrally formed with insert-molding in which the socket housing 11 made of a resin material is filled around the socket contact 12 made of a metal material.

The crown contact 13 is in a leaf spring shape in which its center in the third direction Z warps from the outside of the socket contact 12 toward the inside thereof. The crown contact 13 functions as a leaf spring when the contact 121 is inserted into the socket contact 12. An upper connecting portion for connecting the upper ends of leaf springs of the crown contact 13 and a lower connecting portion for connecting the lower ends of the leaf springs thereof press the inner periphery of the socket contact 12. The leaf springs press the outer periphery of the contact 121. The crown contact 13 enables the socket contact 12 and the contact 121 of the battery connector 100 to be electrically connected.

The latch 41 is caught by the flange 102 when the cable connector 1 and the battery connector 100 mate. At least part of the latch 41 is housed in the latch housing 14 of the socket housing 11 and is formed with a catch portion 41A caught by the flange 102. The latch 41 is pressed from the right side (R) toward the left side (L) in the second direction Y of the housing 11 by a helical compression spring 42 positioned between the socket housing 11 and the latch 41.

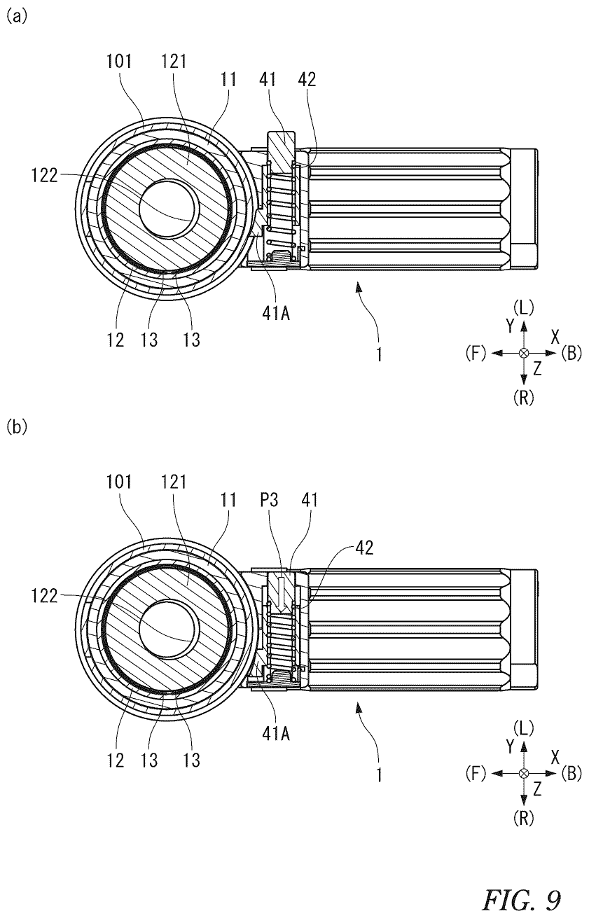

In the present embodiment, a bevel formed on the bottom face of the catch portion 41A of the latch 41, which opposes the flange 102, is pressed by a bevel formed on the flange 102 so that the catch portion 41A moves toward the right side (R) in the second direction Y as depicted in FIG. 9(b). The catch portion 41A remains at the right side (R) in the second direction Y until a catch face 102A of the flange 102 passes through the catch portion 41A toward the upside (U) in the third direction Z. When the catch face 102A passes through the catch portion 41A toward the upside (U) in the third direction Z, the cable connector 1 and the battery connector 100 completely mate. At this time, the latch 41 returns to the original position due to a restoring force of the helical compression spring 42, and the flange 102 completely catches the catch portion 41A.

When the catch face 102A of the flange 102 does not pass through the catch portion 41A toward the upside (U) in the third direction Z and does not completely catch it, the latch 41 is pressed toward the left side (L) in the second direction Y due to a restoring force of the helical compression spring 42. The pressed latch 41 operates from the bevel of the catch portion 41A to the bevel of the flange 102, and a force toward the downside (D) in the third direction Z is applied to the flange 102. The flange 102 does not catch the catch portion 41A, and the cable connector 1 and the battery connector 100 do not completely mate.

When the cable connector 1, which completely mates with the battery connector 100, is detached therefrom, the catch state of FIG. 9(a) is released. The latch 41 is pressed toward the right side (R) in the second direction Y, and the latch 41 is moved in a direction of an arrow P3 in FIG. 9(b) until the flange 102 releases the catch portion 41A. When the flange 102 releases the catch portion 41A, the cable connector 1 can be detached from the battery connector 100.

Indicator Housing 21 and Indicator 30: See FIGS. 1, 2, 4 to 8, and 11

The indicator housing 21 is caught by the socket housing 11. The indicator housing 21 has the window 22 through which the inside of the indicator housing 21 is viewable from the outside thereof, and the visual feature region 33 of the indicator 30 is viewable through the window 22.

The indicator 30 includes a driver 31 which moves, when the cable connector 1 and the battery connector 100 mate, in the third direction Z as a mating direction, a follower 32 which has the visual feature region 33 and which moves from a non-display position to a display position in response to movement of the driver 31, and a helical compression spring 34 as a pressing portion for applying load on the driver 31 such that the follower 32 stays at the non-display position before the cable connector 1 and the battery connector 100 start mating and completely mate.

The driver 31 is provided with a pressing face 31C below a protrusion 31B capable of protruding from the socket housing 11 toward the downside (D) in the third direction Z. When the cable connector 1 and the battery connector 100 mate, the pressing face 31C is pressed by a pressing face 102B at the upside (U) of the flange 102 toward the upside (U) in the third direction Z as a mating direction. When pressed in the third direction Z as a mating direction, the driver 31 moves toward the upside (U) in the third direction Z and the protrusion 31B protruding from the socket housing 11 is covered with the socket housing 11. Further, when the cable connector 1 and the battery connector 100 completely mate, load is applied on the driver 31 in the third direction Z as a mating direction such that the follower 32 stays at the display position. In the present embodiment, the pressing face 102B of the flange 102 of the housing 101 applies load on the driver 31.

The driver 31 has a tilted face 31A which slides along with a tilted face 32A of the follower 32, and the driver 31 moves toward the upside (U) in the third direction Z so that the tilted face 32A slides in response to the tilted face 31A and the follower 32 moves toward the back side (B) in the first direction X. Additionally, the driver 31 and the follower 32 are in a cam-like relationship. The driver 31 serves as a driver cam and has the tilted face 31A as a driver cam face tilted relative to the third direction Z as a mating direction, and the follower 32 has the tilted face 32A as a follower cam face sliding in response to the tilted face 31A as a driver cam face. In the present embodiment, the tilted face 32A as a follower cam face is tilted relative to the third direction Z as a mating direction but is not limited thereto. The follower cam face may be parallel to the third direction Z as a mating direction. Further, either the driver cam face or the follower cam face may be tilted relative to the third direction Z as a mating direction.

When the cable connector 1 and the battery connector 100 completely mate, the follower 32 moves to the display position where the visual feature region 33 is viewable through the window 22. In the present embodiment, the color of the follower 32 is viewed through the window 22 before the cable connector 1 and the battery connector 100 start mating, which is different from the color of the indicator housing 21 around the window 22.

When the cable connector 1 and the battery connector 100 start mating, the driver 31 moves toward the upside (U) in the third direction Z as a mating direction and the follower 32 accordingly moves toward the back side (B) in the first direction X. When the follower 32 starts moving toward the back side (B) in the first direction X, part of the visual feature region 33 is viewable through the window 22. As the cable connector 1 and the battery connector 100 are mating, the area of the visual feature region 33, which is viewable through the window 22, increases.

When the cable connector 1 and the battery connector 100 completely mate, the follower 32 moves from the non-display position to the display position toward the back side (B) in the first direction so that the visual feature region 33 is viewable through the whole window 22. That is, when the cable connector 1 and the battery connector 100 completely mate, there is viewable, through the window 22, the visual feature region 33 displayed in a completely mating state in which the cable connector 1 and the battery connector 100 completely mate. In the present embodiment, the visual feature region 33 displayed in the completely mating state is viewable through the whole window 22.

Further, the visual feature region 33 viewable through the window 22 is in a color different from the color of the follower 32 as the indicator housing 21 and the indicator 30 around the window 22. For the visual feature region 33, for example, a paint with a color different from the colors of the indicator housing 21 and the follower 32 may be applied to the surface of the follower 32, a seal with a color different from the colors of the indicator housing 21 and the follower 32 may be applied to the surface of the follower 32, or a material with a color different from the colors of the follower 32 and the indicator housing 21 may be used for making the follower 32. Additionally, the non-display position is a position of the follower 32 where the visual feature region 33 is not viewable through the window 22 or the color of the follower 32 other than the visual feature region 33 is viewable through the window 22 before the cable connector 1 and the battery connector 100 start mating and completely mate.

The visual feature region 33 is not limited to having a color different from the color of the indicator housing 21 around the window 22. For example, the visual feature region 33 may be formed to be uneven if it is viewable in the completely mating state, a catch structure may be employed in which the follower 32 moves to the display position to be caught by the window 22, or a protrusion structure may be employed in which the follower 32 moves to the display position to protrude outside the indicator housing 21 from the window 22. Further, a protrusion indicating “mating,” “complete,” and the like for notifying complete mating may be formed on the visual feature region 33 even if it is in the same color as the color around the window 22.

Further, a color has the three elements of “hue” indicating the degree of light or dark of a color such as red or blue, “brightness” indicating the relative lightness or darkness of a color, and “chroma” indicating the purity of a color, and any of the three elements may be different from that of a color around the window 22. The most preferable color is white as an achromatic color, but there may be employed a hue which is symmetrical to the hue around the window 22 with respect to a point in the color circle and hues which are near the point-symmetric hue.

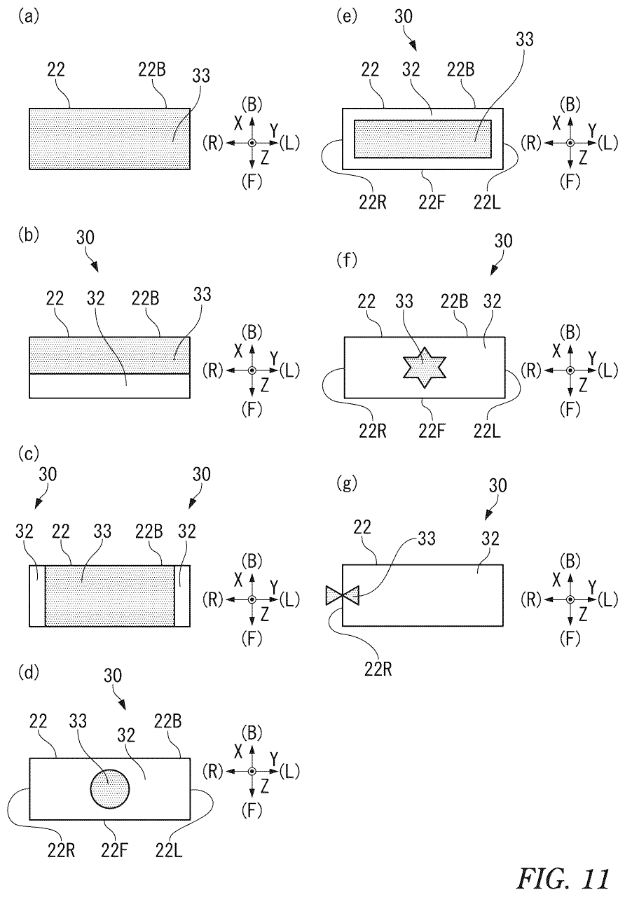

In the present embodiment, the visual feature region 33 displayed in the completely mating state is viewable through the whole window 22 but is not limited thereto. As depicted in FIGS. 11(a) to 11(c), for example, the visual feature region 33 displayed in the completely mating state is viewable through the window 22 while the visual feature region 33 reaches an edge 22B of the window 22 when the follower 32 moves to the display position toward the back side (B) in the first direction X. When the follower 32 stays at the non-display position, the visual feature region 33, which does not reach the edge 22B of the window 22, is viewable through the window 22.

Further, as depicted in FIGS. 11(d) to 11(f), for example, when the follower 32 moves to the display position toward the back side (B) in the first direction X, the visual feature region 33 in one of various shapes may stop not to overlap the edges 22F, 22R, 22B, and 22L of the window 22. The visual feature region 33 displayed in the completely mating state is indicated with reference to the visual feature region 33 depicted in FIGS. 11(d) to 11(f). When the follower 32 stays at the non-display position, the visual feature region 33 in one of various shapes stops at other than the positions of FIGS. 11(d) to 11(f), stops to overlap the edge 22F of the window 22, or the visual feature region 33 is not viewable through the window 22.

Further, as depicted in FIG. 11(g), for example, when the follower 32 moves to the display position toward the back side (B) in the first direction X, the triangle visual feature region 33 as a reference of the indicator may reach a position corresponding to a triangle as a reference of the housing, whose vertex matches the edge 22R of the window 22. When the follower 32 stays at the non-display position, the triangle visual feature region 33 as a reference of the indicator stops at other than the position of FIG. 11(g), stops to overlap the edge 22F of the window 22, or the visual feature region 33 is not viewable through the window 22. Additionally, the visual feature region 33 displayed in the completely mating state is described above by way of example but is not limited thereto.

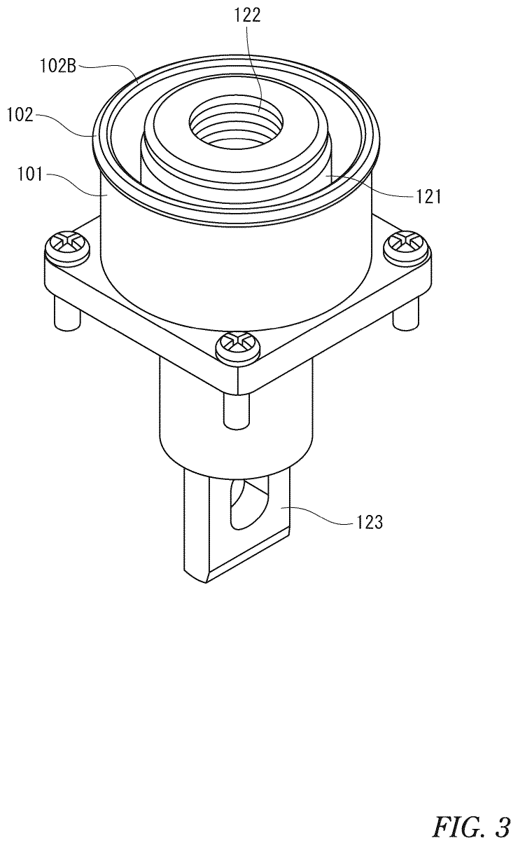

### Battery Connector 100: See FIGS. 1, 3 to 8, and 10

The battery connector 100 mates with the cable connector 1. The cable connector 1 as an electrical connector and the battery connector 100 as a mating connector mate thereby to achieve the connecting element 200 for the electrical connector. The battery connector 100 includes the housing 101 to mate with the cable connector 1, and the contact 121 electrically connectable to the cable connector 1.

The housing 101 is formed, at the upside (U) in the third direction Z, with the flange 102 which catches the catch portion 41A of the cable connector 1. The contact 121 is formed to be cylindrical and is pressed on its cylindrical side face by the crown contact 13 of the cable connector 1 to be electrically connected to the cable connector 1. A terminal 123 electrically connected to a terminal of a battery (not depicted) is connected to the contact 121 at the downside (D) in the third direction Z. Further, the contact 121 is provided with a female screw 122 as a fastening portion on its top face at the upside (U) in the third direction Z. The face where the female screw 122 of the contact 121 is provided is positioned closer to the upside (U) in the third direction Z than the pressing face 102B at the upside (U) of the flange 102.

The housing 101 and the contact 121 include the above components, respectively, and thus the cable connector 1 can mate with the battery connector 100, and additionally a bus bar 400 as a conductive element can be fastened thereto by a hexagon socket screw 300 as a fastening element, for example. The bus bar 400 and the battery connector 100 are fastened to each other thereby to achieve the connecting element 200. Further, a crimp terminal 500 as a conductive element can be fastened to the battery connector 100 by the hexagon socket screw 300 as a fastening element. The crimp terminal 500 and the battery connector 100 are fastened to each other thereby to achieve the connecting element 200.

Thereby, the battery connector 100 can cope with a plurality of connection systems usable by the cable connector 1 and its equivalents.

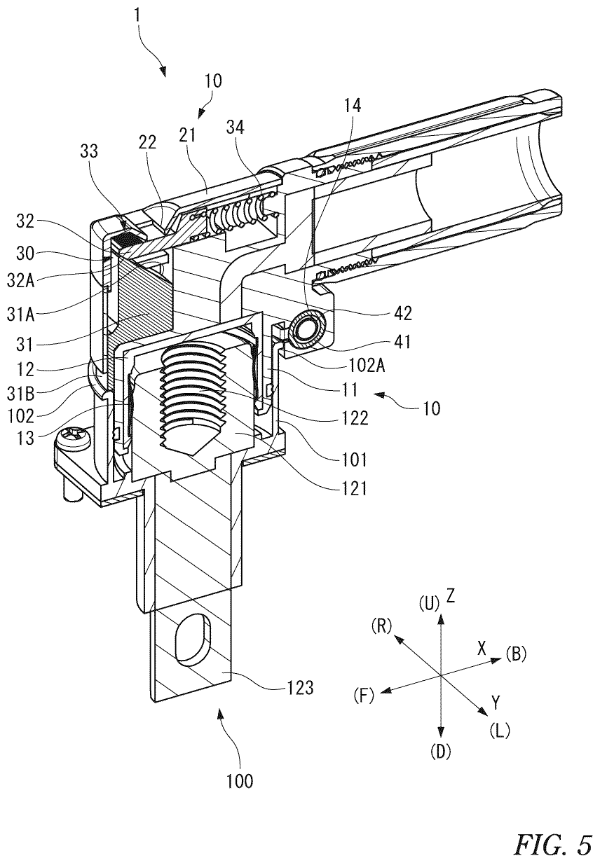

### Cable Connector 1 and Battery Connector 100 Mating: See FIGS. 5 to 7 and 9

FIGS. 5 to 8 are cross sectional views depicting how the cable connector 1 and the battery connector 100 mate. Further, FIG. 9 is diagrams depicting how the catch portion 41A is caught by the flange 102 when the cable connector 1 and the battery connector 100 mate.

As depicted in FIG. 5, in order to mate the cable connector 1 and the battery connector 100, at first the socket housing 11 of the cable connector 1 is inserted between the housing 101 and the contact 121 in the battery connector 100. When the socket housing 11 is inserted, the pressing face 31C of the protrusion 31B of the driver 31 is pressed by the pressing face 102B of the flange 102.

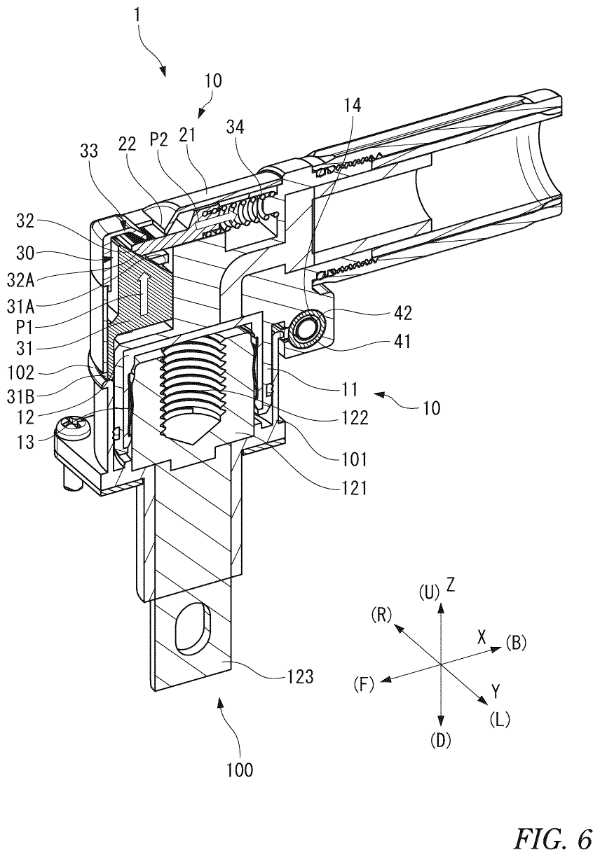

As depicted in FIG. 6, the pressing face 31C of the protrusion 31B of the driver 31 is pressed by the pressing face 102B of the flange 102 and a force P1 toward the upside (U) in the third direction Z is applied to the driver 31. When the driver 31 starts moving toward the upside (U) in the third direction Z as a mating direction, the follower 32 staying at the non-display position starts moving toward the back side (B) in the first direction X. When the follower 32 moves toward the back side (B) in the first direction X, a force P2 toward the back side (B) in the first direction X is applied to the helical compression spring 34. When the follower 32 starts moving toward the back side (B) in the first direction X, part of the visual feature region 33 is viewable through the window 22. While the follower 32 is moving from the non-display position to the display position, the area of the visual feature region 33, which is viewable through the window 22, gradually increases.

Further, the bevel formed on the bottom face of the catch portion 41A is pressed by the bevel formed on the flange 102. The socket housing 11 in the cable connector 1 is being inserted until the catch face 102A of the flange 102 passes through the catch portion 41A toward the upside (U) in the third direction Z.

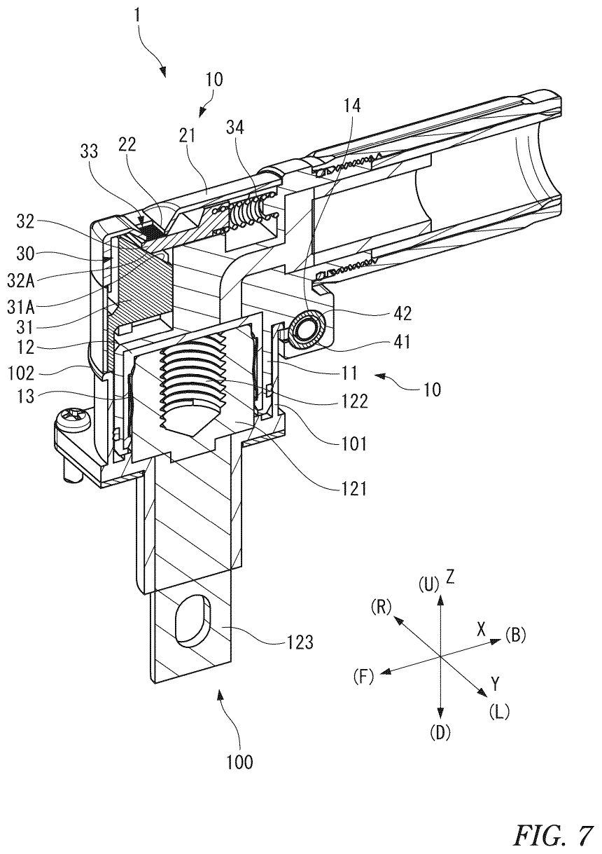

The cable connector 1 and the battery connector 100 completely mate as depicted in FIG. 7. At this time, the follower 32 moves toward the back side (B) in the first direction X and stops moving from the non-display position to the display position. When the follower 32 reaches the display position, the visual feature region 33 is viewable through the whole window 22.

Further, when the cable connector 1 and the battery connector 100 completely mate, the catch face 102A can pass through the catch portion 41A toward the upside (U) in the third direction Z.

As depicted in FIG. 9(a), when the cable connector 1 and the battery connector 100 completely mate, the latch 41 returns to the original position due to a restoring force of the helical compression spring 42, and the flange 102 completely catches the catch portion 41A.

### Effects of Embodiment

[Effect 1] The cable connector 1 includes the socket housing 11 to mate with the battery connector 100, the indicator housing 21 having the window 22, and the indicator 30 at least part of which is housed in the socket housing 11 and which has the visual feature region 33 viewable through the window 22, the indicator 30 includes the driver 31 which moves, when the cable connector 1 and the battery connector 100 mate, in the third direction Z as a mating direction, and the follower 32 which has the visual feature region 33 and which moves from the non-display position to the display position in the visual feature region 33 in response to movement of the driver 31, and the follower 32 moves to the display position where the visual feature region 33 is viewable through the window 22 when the cable connector 1 completely mates with the battery connector 100. Thereby, it is possible to visually confirm whether the cable connector 1 and the battery connector 100 completely mate or whether the electrical connector is completely mounted.

[Effect 2] The battery connector 100 includes the housing 101 to mate with the cable connector 1, and the contact 121 which is fastened to the bus bar 400, the crimp terminal 500, or the like as a conductive element by the hexagon socket screw 300 as a fastening element and which is provided with the female screw 122 as a conductive fastening element. Thereby, a plurality of connection systems usable by the cable connector 1 and its equivalents can be coped with.

The components according to the embodiment are not limited to the above, and may be deleted, added, or changed to other components without departing from the spirit of the present invention.

In the present embodiment, the cable connector 1 includes the indicator housing 21 having the window 22, and the indicator 30 at least part of which is housed in the socket housing 11, which has the visual feature region 33, and which includes the follower 32 moving from the non-display position to the display position in the visual feature region 33 in response to movement of the driver 31. Additionally, when the cable connector 1 and the battery connector 100 completely mate, the follower 32 moves to the display position where the visual feature region 33 is viewable through the whole window 22 but is not limited the configuration.

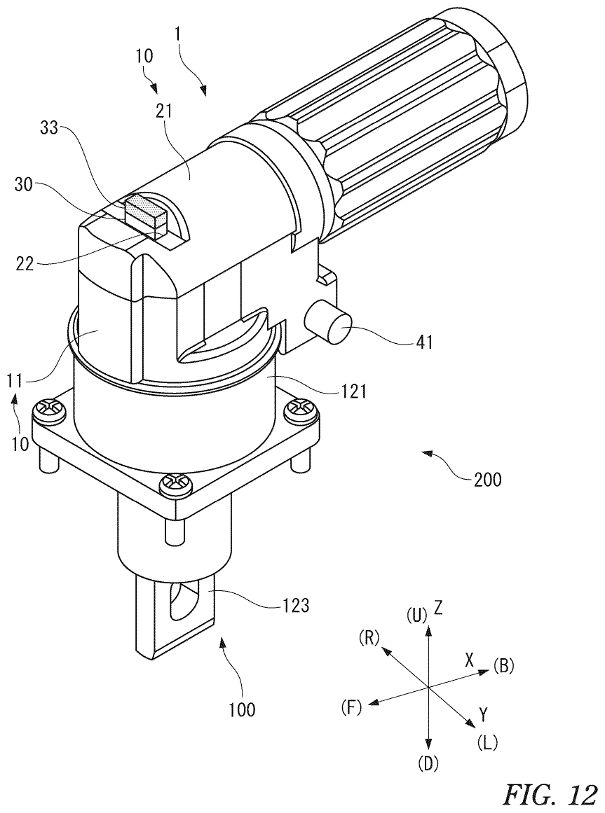

As depicted in FIG. 12, the cable connector 1 includes the housing 10 to mate with the battery connector 100 as a mating connector, and the indicator 30 at least part of which is housed in the housing 10, which has the visual feature region 33, and which moves, when the cable connector 1 mates with the mating connector, from the non-display position to the display position toward the upside (U) in the third direction Z as a mating direction. Additionally, when the cable connector 1 and the battery connector 100 completely mate, the indicator 30 moves to the display position where the visual feature region 33 is viewable from outside the housing 10.

Also, in the thus-configured cable connector 1, it is possible to visually confirm whether the cable connector 1 and the battery connector 100 completely mate or whether the electrical connector is completely mounted.

Additionally, in FIG. 12, the indicator 30 protrudes outside the indicator housing 21 from the window 22 of the indicator housing 21, and thus the visual feature region 33 is viewable from outside the indicator housing 21 and the socket housing 11.

In the present embodiment, the driver 31 has the tilted face 31A which slides along with the tilted face 32A of the follower 32, and the driver 31 moves toward the upside (U) in the third direction Z so that the tilted face 32A slides in response to the tilted face 31A and the follower 32 moves toward the back side (B) in the first direction X, but the present embodiment is not limited to the configuration. For example, in order to change the motion direction, a lever with the center of rotation connecting the driver 31 and the follower 32 may be provided to convert motion of the driver 31 in the third direction Z into rotation of the lever and then to convert the rotation of the lever into motion of the follower 32 in the first direction X. Also with the configuration, the follower 32 can move from the non-display position to the display position so that the visual feature region 33 is viewable through the whole window 22.

Further, the helical compression spring 34 serves as a pressing portion for applying load on the driver 31 such that the follower 32 stays at the non-display position but is not limited thereto. A leaf spring, a twisted spring, and the like capable of applying load on the driver 31 such that the follower 32 stays at the non-display position may be used.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An electrical connector, comprising:
a housing adapted to mate with a mating connector; and
an indicator at least part of which is housed in the housing, the indicator including a visual feature region movable as the housing mates with the mating connector from a non-display position to a display position in a mating direction, as the housing completely mates with the mating connector, the indicator moves from the non-display position to the display position where the visual feature region is viewable from outside the housing.

2. The electrical connector according to claim 1, wherein the housing includes a window permitting view of an inside of the housing from an outside of the housing, the visual feature region being viewable through the window.

3. The electrical connector according to claim 2, wherein the indicator comprises:
a driver movable in a mating direction when the housing mates with the mating connector; and
a follower having the visual feature region and which moves from the non-display position to the display position in response to movement of the driver.

4. The electrical connector according to claim 3, wherein when the housing completely mates with the mating connector, the follower moves to the display position wherein the visual feature region is viewable through the window.

5. The electrical connector according to claim 4, wherein:
the driver has a driver cam face which is inclined relative to the mating direction, and
the follower has a follower cam face slidable along the driver cam face.

6. The electrical connector according to claim 4, wherein the housing includes a pressing portion adapted to apply load on the driver such that the follower remains at the non-display position when the housing does not completely mate with the mating connector.

7. The electrical connector according to claim 6, wherein the pressing portion elastically biases the follower into contact with the driver.

8. The electrical connector according to claim 7, wherein the pressing portion comprises a compression spring.

9. The electrical connector according to claim 6, wherein when the housing completely mates with the mating connector, load is applied on the driver in a mating direction such that the follower stays at the display position.

10. The electrical connector according to claim 2, wherein when the housing completely mates with the mating connector, the indicator moves to the display position where the visual feature region displayed in a completely mated state in which the housing completely mates with the mating connector is viewable through the window.

11. The electrical connector according to claim 2, wherein when the housing does not completely mate with the mating connector, the indicator remains at the non-display position where the visual feature region is not viewable through the window or a region other than the visual feature region is viewable through the window.

12. The electrical connector according to claim 1, wherein the visual feature region is in a color distinct from a color of the housing.

13. The electrical connector according to claim 1, further comprising a latch adapted to selectively lock the mating connector in a completely mated with the electrical connector.

14. A mating connector comprising:
a housing configured to mate with the electrical connector according to claim 1, and
a contact adapted to be fastened to a conductive element with a fastening element, and provided with a conductive fastening portion.

15. A connecting element comprising:
an electrical connector, including:
a housing adapted to mate with a mating connector; and
an indicator at least part of which is housed in the housing, the indicator including a visual feature region movable as the housing mates with the mating connector from a non-display position to a display position in a mating direction, as the housing completely mates with the mating connector, the indicator moves from the non-display position to the display position where the visual feature region is viewable from outside the housing; and
a mating connector, including:
a housing mateable with the electrical connector; and
a contact adapted to be fastened to a conductive element with a fastening element, and provided with a conductive fastening portion.

16. The connecting element according to claim 15, wherein the electrical connector further comprises a latch selectively locking the mating connector in a completely mated with the electrical connector.

17. The connecting element according to claim 16, wherein the housing of the mating connector includes a flange selectively engaging with the latch of the electrical connector as the mating connector is mated with the electrical connector.

18. The connecting element according to claim 15, wherein the housing includes a window permitting view of an inside of the housing from an outside of the housing, the visual feature region being viewable through the window.

19. The connecting element according to claim 18, wherein:
the indicator comprises:
a driver movable in a mating direction when the housing mates with the mating connector; and
a follower having the visual feature region and which moves from the non-display position to the display position in response to movement of the driver; and
when the housing completely mates with the mating connector, the follower moves to the display position wherein the visual feature region is viewable through the window.

20. The connecting element according to claim 19, wherein:
the driver has a driver cam face which is inclined relative to the mating direction, and
the follower has a follower cam face slidable along the driver cam face.
